(19) United States
(12) Patent Application Publication
(10) Pub. No.: US 2009/0154347 A1
(43) Pub. Date: Jun. 18, 2009

(54) PACING OF TRANSPORT STREAM TO COMPENSATE FOR TIMESTAMP JITTER

(75) Inventors: Rajesh S. Mamidwar, San Diego, CA (US); Wade Wan, Orange, CA (US); John Jordan, Santa Cruz, CA (US)

Correspondence Address: GARLICK HARRISON & MARKISON, P.O. BOX 160727, AUSTIN, TX, 78716-0727, US

(73) Assignee: Broadcom Corporation, Irvine, CA (US)

(21) Appl. No.: 11/954,663

(22) Filed: Dec. 12, 2007

(51) Int. Cl. H04L 12/26; G08C 15/00

(52) U.S. Cl. 370/229

(57) ABSTRACT

De-jittering a transport stream, at least some transport packets of the transport stream carrying audio-video data and at least some of the transport packets of the transport stream containing Program Clock References (PCRs). A data buffer receives the transport packets and stores the transport packets. Pacing counter clock circuitry produces a pacing counter clock and adjusts the pacing counter clock based upon a pacing counter clock adjust signal. Pacing control circuitry produces the pacing counter clock adjust signal based upon receipt of the transport packets. PCR packet pacing circuitry receives the pacing counter clock, based upon the packing counter clock, retrieves transport packets from the data buffer, and transmits the retrieved transport packets as an output transport stream. The pacing counter clock adjust signal may be based upon data buffer fullness or based upon an estimated program clock generated from the PCRs.

### BACKGROUND

1. Technical Field of the Invention

This invention relates generally to multimedia content transport, and more particularly to the receipt and processing of such multimedia content.

2. Related Art

The broadcast of digitized audio/video information (multimedia content) is well known. Limited access communication networks such as cable television systems, satellite television systems, and direct broadcast television systems support delivery of digitized multimedia content via controlled transport medium. In the case of a cable modem system, a dedicated network that includes cable modem plant is carefully controlled by the cable system provider to ensure that the multimedia content is robustly delivered to subscribers' receivers. Likewise, with satellite television systems, dedicated wireless spectrum robustly carries the multi-media content to subscribers' receivers. Further, in direct broadcast television systems such as High Definition (HD) broadcast systems, dedicated wireless spectrum robustly delivers the multi-media content from a transmitting tower to receiving devices. Robust delivery, resulting in timely receipt of the multimedia content by a receiving device is critical for the quality of delivered video and audio.

Some of these limited access communication networks now support on-demand programming in which multimedia content is directed to one, or a relatively few number of receiving devices. The number of on-demand programs that can be serviced by each of these types of systems depends upon, among other things, the availability of data throughput between a multimedia source device and the one or more receiving devices. Generally, this on-demand programming is initiated by one or more subscribers and serviced only upon initiation.

Publicly accessible communication networks, e.g., Local Area Networks (LANs), Wireless Local Area Networks (WLANs), Wide Area Networks (WANs), Wireless Wide Area Networks (WWANs), and cellular telephone networks, have evolved to the point where they now are capable of providing data rates sufficient to service streamed multimedia content. The format of the streamed multimedia content is similar/same as that that is serviced by the limited access networks, e.g., cable networks, satellite networks. However, each of these communication networks is shared by many users that compete for available data throughput. Resultantly, data packets carrying the streamed multimedia content are typically not given preferential treatment by these networks.

Generally, streamed multimedia content is formed/created by a first electronic device, e.g., web server, transmitted across one or more commutation networks, and received and processed by a second electronic device, e.g., personal computer, laptop computer, cellular telephone, WLAN device, or WWAN device. In creating the multimedia content, the first electronic device obtains/retrieves multimedia content from a video camera or from a storage device, for example, and encodes the multimedia content to create encoded audio and video frames according to a standard format, e.g., MPEG-2 format. The audio and video frames are placed into data packets that are sequentially transmitted from the first electronic device onto a servicing communication network, the data packets addressed to one or more second electronic device(s). One or more communication networks carry the data packets to the second electronic device. The second electronic device receives the data packets, reorders the data packets, if required, and extracts the audio and video frames from the data packets. A decoder of the second electronic device receives the data packets and reconstructs a program clock based upon Program Clock References (PCRs) contained in the transport packets. The decoder then uses the reconstructed clock to decode the audio and video frames to produce audio and video data. The second electronic device then stores the video/audio data and/or presents the video/audio data to a user via a user interface.

To be compliant to the MPEG-2 Systems specification, PCRs are required to be inserted at least every 100 milliseconds in a MPEG-2 transport stream. In order for the second electronic device to accurately reconstruct the program clock, e.g., at 27 MHz, incoming transport packets must arrive at the decoder of the second electronic device with jitter that is less than approximately 1-2 milliseconds/30 parts-per-million (PPM). Data packets that are transported by communication networks such as the Internet, WANs, LANs, WWANs, WLANs, and/or cellular networks, for example, using Internet Protocol (IP) addressing, for example, may travel via differing routes across one or more communication networks and arrive with various transmission latencies. In many operations, the data packets carrying timestamps arrive with significant jitter, sometimes approaching 200-400 parts-per-million jitter. With this large jitter, the receiving decoder may be unable to recreate the program clock from the received data packets. Further, even if the decoder is able to recreate the program clock, the recreated program clock may have a significantly different frequency than the program clock of the encoding first device. Such differences in the recreated program clock of the decoder of the second electronic device as compared to the program clock of the encoder of the first electronic device results in buffer overflow or underflow at the second electronic device. Buffer overflow causes some of the incoming data to be purged and not buffered resulting in lost data and poor audio or video quality. Buffer underflow causes starvation of the decoder also resulting in poor audio or video quality.

Thus, a need exists for a streamed transport system that operates satisfactorily with a high jitter transport stream, e.g. the Internet, and that produces video and audio output of high quality. Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a system diagram illustrating a number of networks and electronic devices that support transport stream de-jittering according to one or more embodiments of the present invention;

FIG. 2 is an abbreviated system diagram illustrating interaction between an audio/video source and an audio/video player that includes transport stream jitter removal circuitry according to one or more embodiments of the present invention;

FIG. 3 is an abbreviated system diagram illustrating interaction among an audio/video source, an electronic device that includes transport stream jitter removal circuitry according to one or more embodiments of the present invention, and an audio/video player;

FIG. 4 is a block diagram illustrating a structure for de-jittering a transport stream according to one or more embodiments of the present invention;

FIG. 5 is a block diagram illustrating a video processing structure that de-jitters a transport stream according to embodiments of the present invention and that decodes an output video;

FIG. 6 is a block diagram of an electronic device operable to de-jitter a transport stream, decode the audio and video content carried by the transport stream, and present the audio and video content;

FIG. 7 is a block diagram illustrating an electronic device for receiving a jittery transport stream, de-jittering the received transport stream, and producing an output transport stream having reduced jitter characteristics; and

FIG. 8 is a flow chart illustrating operations according to one or more embodiments of the present invention.

### DETAILED DESCRIPTION OF THE DRAWINGS

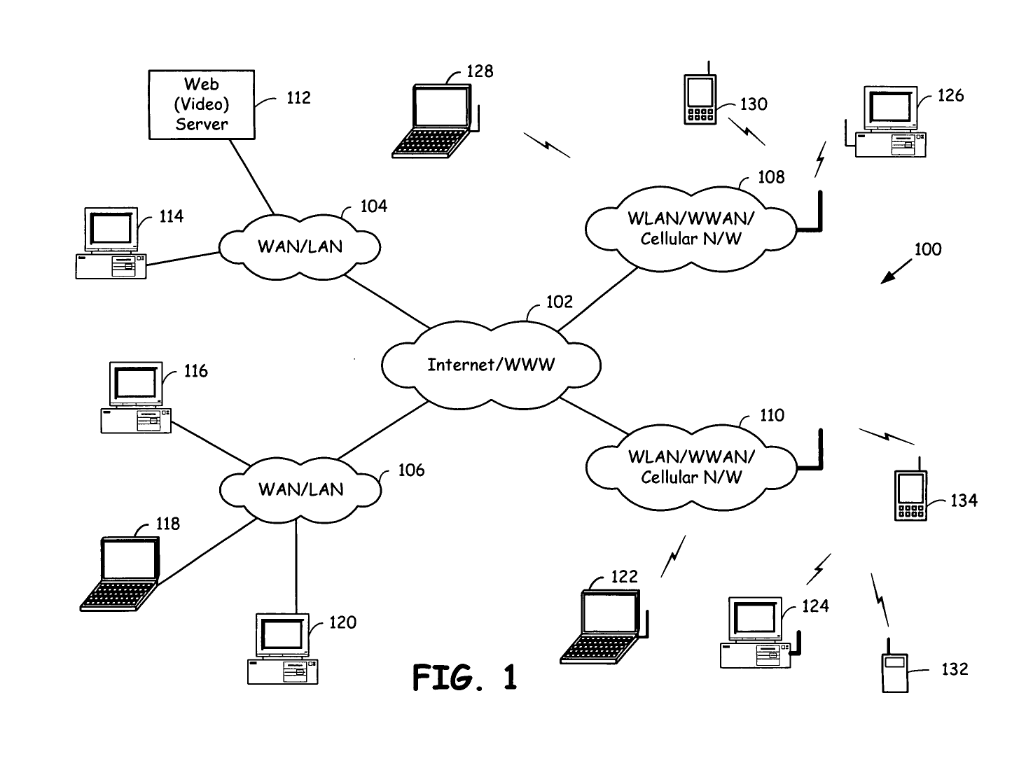

FIG. 1 is a system diagram illustrating a plurality of networks and electronic devices that support transport stream de-jittering operations and structures according to one or more embodiments of the present invention. The system 100 of FIG. 1 includes a plurality of communication networks 102, 104, 106, 108, and 110 that service a plurality of electronic devices 114, 116, 118, 120, 122, 124, 126, 128, 130, 132, and 134. These communication networks include the Internet/World Wide Web (WWW) 102, one or more Wide Area Networks/Local Area Networks (WANs/LANs) 104 and 106, and one or more Wireless Wide Area Networks/Wireless Local Area Networks/Cellular networks (WLANs/WWANs/Cellular networks) 108 and 110. The Internet/WWW 102 is generally known and supports Internet Protocol (IP) operations. The WANs/LANs 104 and 106 support electronic devices 114, 116, 118, and 120 and support IP operations. The WLANs/WWANs/Cellular networks 108 and 110 support electronic devices 122, 124, 126, 128, 130, 132, and 134 and also support IP operations.

Generally, the Internet/WWW 102 (and in many cases the WANs/LANs) cannot guarantee delivery of data packets (and audio/video frames carried therein) with jitter of 1-2 milliseconds. It is possible for the jitter of data packets carried by the Internet/WWW to exceed hundreds of milliseconds. Thus, any transport stream (transport packet stream) traversing the Internet/WWW 102 could have jitter of 100s of milliseconds. WANs/LANs 104 and 106 support data transport of a transport stream with less jitter than that provided by the Internet/WWW 102 in some operations. However, in other operations, the WAN/LANs 104 and 106 cannot guarantee delivery of the transport packets of the transport stream with a lower jitter figure.

The WLAN/WWAN/Cellular networks 108 and 110 operate according to one or more wireless interface standards, e.g., IEEE 802.11x, WiMAX, GSM, EDGE, GPRS, WCDMA, CDMA, 1xEV-DO, 1xEV-DV, etc. The WLAN/WWAN/Cellular networks 108 and 110 include a back-haul network that couples to the Internet/WWW 102 and service wireless links for wirelessly enabled electronic devices 122, 124, 126, 128, 130, 132, and 134. In providing this wireless service, the WLAN/WWAN/Cellular networks 108 and 110 include infrastructure devices, e.g., Access Points and base stations to wirelessly service the electronic devices 122, 124, 126, 128, 130, 132, and 134. The wireless links serviced by the WLAN/WWAN/Cellular networks 108 and 110 are shared amongst the wirelessly enabled electronic devices 124-134 and are generally data throughput limited. Such data throughput limitations result because the wireless links are shared, the wireless links are degraded by operating conditions, and/or simply because the wireless links have basic data throughput limitations. Thus, the WLAN/WWAN/Cellular networks 108 and 110 typically introduce additional jitter into a serviced transport stream that is in addition to the jitter introduced by the Internet/WWW 102.

Generally, the servicing networks 104, 106, 102, 108, and 110 illustrated in FIG. 1 cannot support the low jitter figures of approximately 300 parts-per-million or 1-2 milliseconds required for quality audio/video decoding by a decoding electronic device. Thus, according to the present invention, one or more of the electronic devices 114-134 includes transport stream jitter removal circuitry constructed according to one or more embodiments to the present invention.

With an example of operation according to the present invention, a web server 112 establishes an audio/video session with one or more of electronic devices 114, 120, 122, and/or 130. The web server 112 initially sets up the audio/video session with these devices 114, 120, 122, and/or 130 and then creates a transport stream that carries encoded audio/video frames/data. Some of the transport packets include Program Clock References (PCRs). The web server 112 may package the transport packets into larger/other data packets, address the data packets to devices 114, 120, 122, and/or 130 and transmit the data packets onto WAN/LAN 104. Networks 104, 106, 102, 108, and/or 110 deliver the data packets to the receiving electronic devices 114, 120, 122, and/or 130. However, the servicing networks 102, 104, 106, 108, and/or 110 introduce jitter into the transported data packets. Differences in transport latency from data packet to data packet are exhibited as jitter of the transport stream. The jitter of the transport of the data packets from the web server 112 to each of the electronic device 114, 120, 122, and/or 130 may differ. Further, the jitter of each transport stream (between web server 112 and a corresponding receiving device) may vary over time, depending upon network loading, wireless link limitations, equipment outages, the weather, etc. The reader should note that transport packets and data packets, although referred to separately herein, may be the same data structures in some embodiments and need not be separate or differing structures. In some embodiments, the transport packets that are made up of audio/video frames are carried by IP packets, which are one example of data packets that differ from transport packets. In still other embodiments, audio frames and/or video frames may be packaged into differing data packets. Further, “transport packet stream” and “transport stream” may be referred to interchangeably herein for clarity purposes and, in some embodiments, are the same thing.

Each electronic device 114, 120, 122, and/or 130 eventually receives most or all of the transport packets of the transport stream. However, the transport packets are effectively received on an irregular basis as compared to the PCRs that they carry. According to one example of the operations of system 100 of FIG. 1, the transport packet stream is formed consistently with the MPEG-2 operating standard and the PCRs are inserted into transport packets by web server 112 at least every 100 milliseconds. Each receiving device, e.g., electronic device 130 includes a decoder that reconstructs a program clock from the PCRs extracted from the transport packets and uses the program clock to decode the transport packets of the transport packet stream. However, because the transport packets are received with substantial jitter, reconstruction of the program clock from the PCRs of the transport packet is difficult or impossible.

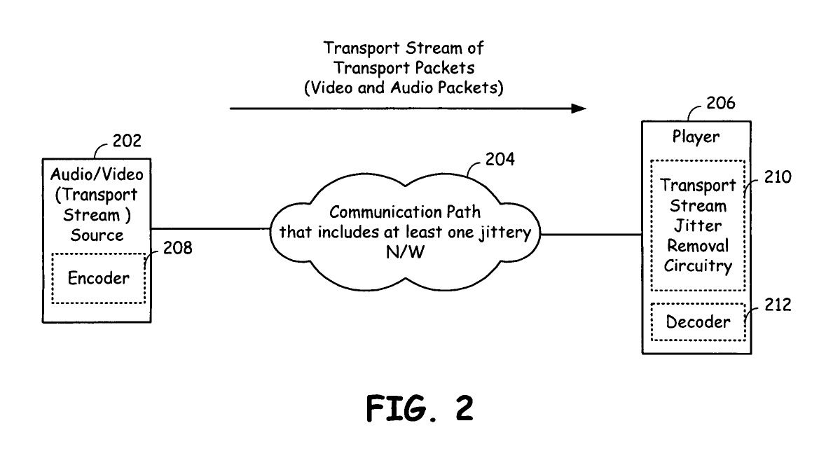

Thus, according to one or more embodiments of the present invention, electronic devices 114, 120, 122, and 130 includes transport stream jitter removal circuitry that removes the jitter from the received transport packets of the transport packet stream prior to reconstructing the program clock from the PCRs. The structure and operation of the jitter removal circuitry will be described further with reference to FIGS. 2-8. By removing the jitter from the transport packet stream, the receiving electronic devices 114, 120, 122, and 130 are able to create a program clock from the PCRs and then to decode the transport packet stream to create quality audio/video output.

According to other operations of the system 100 of FIG. 1, any of the electronic devices 114, 116, 118, 120, 122, 124, 126, 128, 130, 132, or 134 may create a transport packet stream and transmit the transport packet stream. Each of these devices 114-134 may transmit the transport packet stream that carries the transport packets to any other of the electronic devices or to the web server 112. Another of the electronic devices 114-134 may receive the transport packet stream and use its jitter removal circuitry to remove jitter from the received transport packet stream prior to decoding and presentation.

FIG. 2 is an abbreviated system diagram illustrating interaction between a video source and an audio/video player that includes transport stream jitter removal circuitry according to one or more embodiments of the present invention. Generally, an audio/video source 202 includes an encoder 208 that creates a transport packet stream of audio/video frames, which are packaged into transport packets. Some of the transport packets of the transport packet stream carry PCRs. The transport packet stream may be compliant with the MPEG-2 standard, for example.

The audio/video source 202 transmits the data packets (carrying the transport packets of the transport packets stream) upon a communication path 204 that includes at least one jittery network. The communication path 204 carries the data packets carrying the transport packets to audio/video player 206. However, the transport packets of the transport packet stream are received by audio/video player 206 with significant jitter, e.g. hundreds of milliseconds of jitter. The audio/video 206 includes transport stream jitter removal circuitry 210 and a decoder 212. The decoder 212 cannot operate upon the jittery transport stream to recreate a program clock accurately. Because the received transport stream is too jittery, the decoder 212 would create an inaccurate program clock that would cause buffer underflow or overflow resulting in poor quality of output audio/video. Thus, according to the present invention, the transport stream jitter removal circuitry 210 of the audio/video 206 operates upon the transport stream (after extraction from the data packet stream) to remove jitter prior to providing the transport stream to decoder 212. In such case, the transport stream jitter removal circuitry 210 substantially/fully removes the jitter introduced by the communication path 204 prior to operation upon the transport stream by the decoder 212.

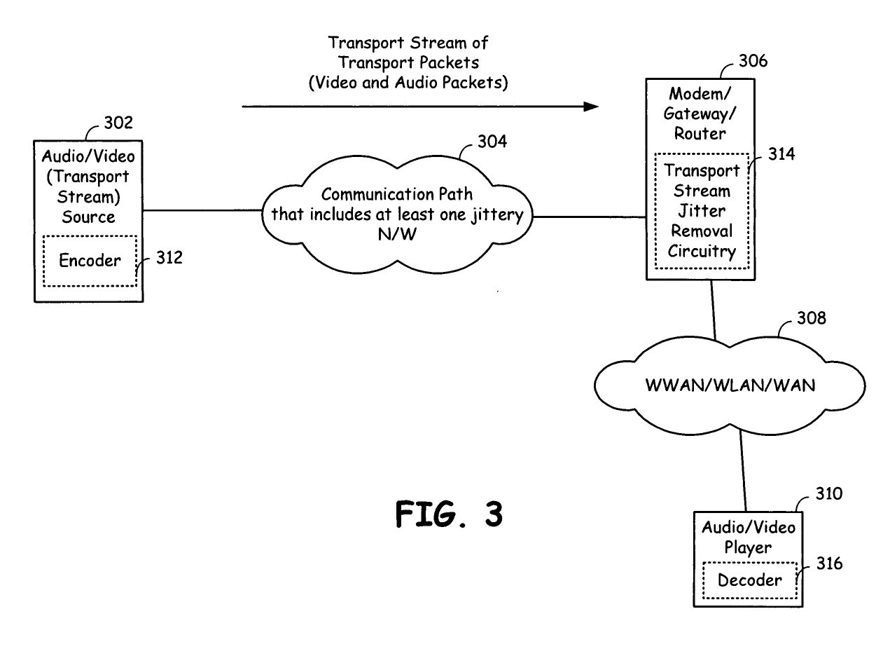

FIG. 3 is an abbreviated system diagram illustrating interaction among an audio/video source, an electronic device that includes transport stream jitter removal circuitry according to one or more embodiments of the present invention, and an audio/video player. Audio/video source 302 includes encoder 312 that creates a transport stream of a plurality of audio/video frames. The audio/video source 302 packages the audio/video frames into transport packets and transmits the transport packets onto a coupled network. The transport packets may be carried by data packets of particular types, e.g., IP packets. Communication path 304 introduces jitter into the data packet stream (transport stream), the amount of jitter introduced perhaps exceeding the amount of jitter upon which a decoder 316 of audio/video player 310 can adequately operate.

Thus, according to the embodiment of FIG. 3, the modem/gateway/router 306 includes transport stream jitter removal circuitry 314. The transport stream jitter removal circuitry 314 operates upon the transport packets extracted from the received data packets to remove at least some of the jitter introduced into the transport stream by the communication path 304. However, as contrasted to the embodiment of FIG. 2, the modem/gateway/router 306, after operating upon the transport stream, outputs a reduced jitter version of the transport stream onto WWAN/WLAN/WAN 308. In such case, the modem/gateway/router 306 packages the de-jittered version of the transport stream into data packets. Presumptively, the WWAN/WLAN/WAN 308 introduces a relatively small amount of jitter into the de-jittered transport stream that is output by modem/gateway/router 306. The de-jittered transport stream produced by the modem/gateway/router 306 onto network 308 is eventually received by audio/video 310. Decoder 316 within audio/video 312 decodes the transport stream to produce audio/video content for presentation upon the audio/video player 310.

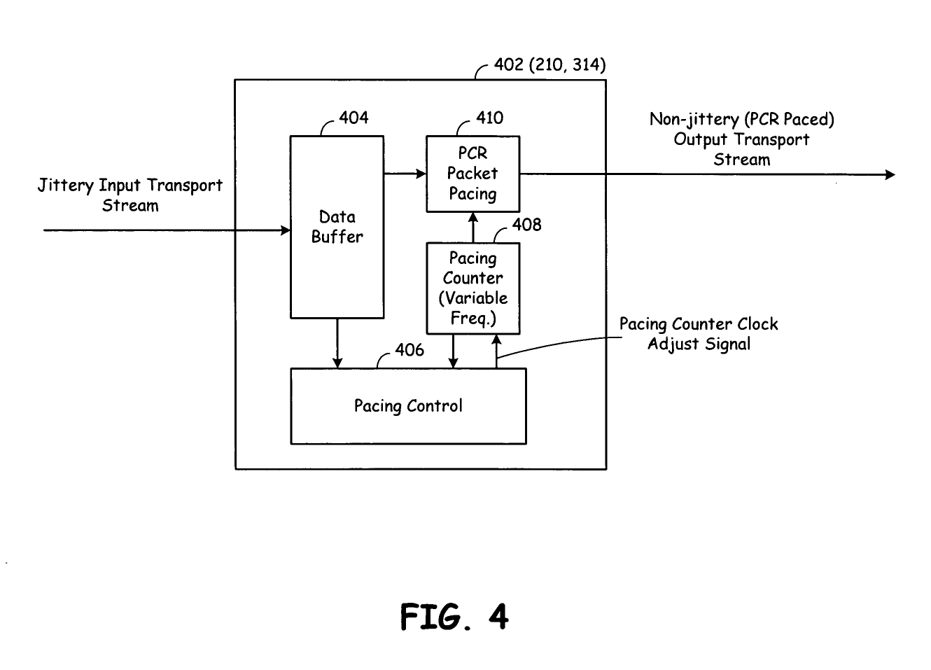

FIG. 4 is a block diagram illustrating a structure for de-jittering a transport stream according to one or more embodiments of the present invention. The structure illustrated in FIG. 4 may be implemented in hardware, software, or a combination of hardware and software. Transport stream jitter removal circuitry 402 (210,314) receives a jittery input transport stream. This jittery input transport stream includes transport packets, at least some of which also carry PCRs. The transport packets of the transport stream may be carried in data packets received from an audio/video source. The reader should understand that the transport stream may include audio and/or video data, and other information that could be carried in a transport stream of this sort. For example, the transport stream may also carry a plurality of video communications, a plurality of audio communications, and other information such as graphical information that may be employed by a receiving device. The transport stream described herein with reference to the present invention is not to be construed narrowly in considering the type of content that may be carried by such transport stream.

The transport stream jitter removal circuitry 402 includes a data buffer 404, pacing control circuitry 406, pacing counter clock circuitry 408, and PCR packet pacing circuitry 410. The data buffer 404 is operable to receive the transport packets of the transport stream jittery input transport stream) and to store the transport packets. The pacing counter clock circuitry 408 is operable to produce a pacing counter clock and to adjust a frequency of the pacing counter clock based upon a pacing counter clock adjust signal. The pacing control circuitry 406 is operable to produce the pacing counter clock adjust signal based upon receipt of the transport packets. The PCR packet pacing circuitry 410 is operable to receive the pacing counter clock from pacing counter clock circuitry 408 and, based upon the pacing counter clock, to receive transport packets from the data buffer 404. The PCR pacing circuitry 410 is further operable to transmit the retrieved transport packets as an output transport stream. The output transport stream is also referred to in FIG. 4 as a non-jittery (PCR paced) output transport stream. The content of the non-jittery (PCR paced) output transport stream is the same as that of the jittery input transport stream.

According to one operation of the embodiment of FIG. 4, in producing the pacing counter clock adjust signal based upon receipt of the transport packets, the pacing control circuitry 406 is operable to first receive the PCRs of the transport packets as they are received by data buffer 404. This operation may include the data buffer 404 stripping the PCRs from the transport packets as they are received and then forwarding the PCRs to the pacing control circuitry 406. Alternately, the pacing control circuitry 406 may snoop the transport packets of the transport stream as they are received by the data buffer 404 and extract the PCRs.

In one embodiment of operation according to the present invention, pacing control circuitry 406 is operable to process the PCRs of the transport packets to estimate a frequency of a program clock of an electronic device producing the transport stream. For example, referring again to FIG. 1, the web server 112 has a program clock that it uses to generate the transport stream. Jitter removal circuitry 402, resident in laptop computer 122 that receives data packets carrying the transport packets of the transport stream, for example, processes the PCRs of the transport packets to estimate the frequency of the program clock of the web server 112 that was used to produce the transport stream.

Then, referring again to FIG. 4, the pacing control circuitry 406 is operable to compare the estimated frequency of the program clock of the electronic device (web server 112) producing the transport packets containing the PCRs to the pacing counter clock produced by pacing counter clock circuitry 408. Then, based upon this comparison of the estimated frequency of the program clock of the electronic device producing the transport packets containing the PCRs to the pacing counter clock produced by the pacing counter clock circuitry 408, the pacing control circuitry 408 produces the clock adjust signal. For example, if the pacing control circuitry 406 determines that the pacing counter clock is too slow, the pacing control circuitry 406 directs the pacing counter clock circuitry to increase the frequency of the pacing counter clock via the pacing counter clock adjust signal. Alternatively, should the pacing control circuitry 406 determine that the pacing counter clock is too fast, the pacing control circuitry 406 directs the pacing counter clock adjust signal to decrease the frequency of the pacing counter clock via the pacing counter clock adjust signal.

According to another operation of the pacing control circuitry 406, in producing the pacing counter clock adjust signal based upon the transport packets, the pacing control circuitry 406 characterizes the fullness of the data buffer 404. The pacing control circuitry 406 then compares the fullness of the data buffer 404 to a fullness threshold. Then, based upon this comparison the pacing control circuitry 406 produces the pacing counter clock adjust signal. For example, in one particular embodiment, it may be desirable for the data buffer 404 to be approximately 50% full at all times. When the data buffer 404 becomes more than 50% full, the pacing control circuitry 406 directs an increase in frequency of the pacing counter clock using the pacing counter clock adjust signal. Alternatively, when the data buffer 404 is less than 50% full, the pacing control circuitry 406 determines that the frequency of the pacing counter clock should be decreased and produces an appropriate pacing counter clock adjust signal.

In still another embodiment, the fullness thresholds may be set at more than one level. For example, if the data buffer 404 is more than 70% full, the pacing control circuitry 406 may direct the pacing counter clock circuitry 408 to increase the frequency of the pacing counter clock via the pacing counter clock adjust signal. Further, when the data buffer is less than 30% full, the pacing control circuitry 406 may direct the pacing counter clock circuitry 408 to decrease the frequency of the pacing counter clock via the pacing counter clock adjust signal. In this fashion, the pacing control circuitry 406 will effectively control the pacing counter clock frequency so that the data buffer 404 remains between 30% and 70% full. With these data fullness thresholds met, the likelihood that the decoder that is decoding the transport stream will not underflow or overflow increases.

According to another aspect of the transport stream jitter removal circuitry 402 of FIG. 4, the jittery input transport stream has first jitter characteristics and the non-jittery output transport stream has second jitter characteristics. As should be evident to the reader, the second jitter characteristics are less jittery than the first jitter characteristics. Considering the example of the Internet as a transport path, the Internet may introduce jitter into the input transport stream on the order of 100s of milliseconds. However, the output transport stream may have jitter on the order of 1-2 milliseconds, which is sufficient for most decoders operating upon the output transport stream.

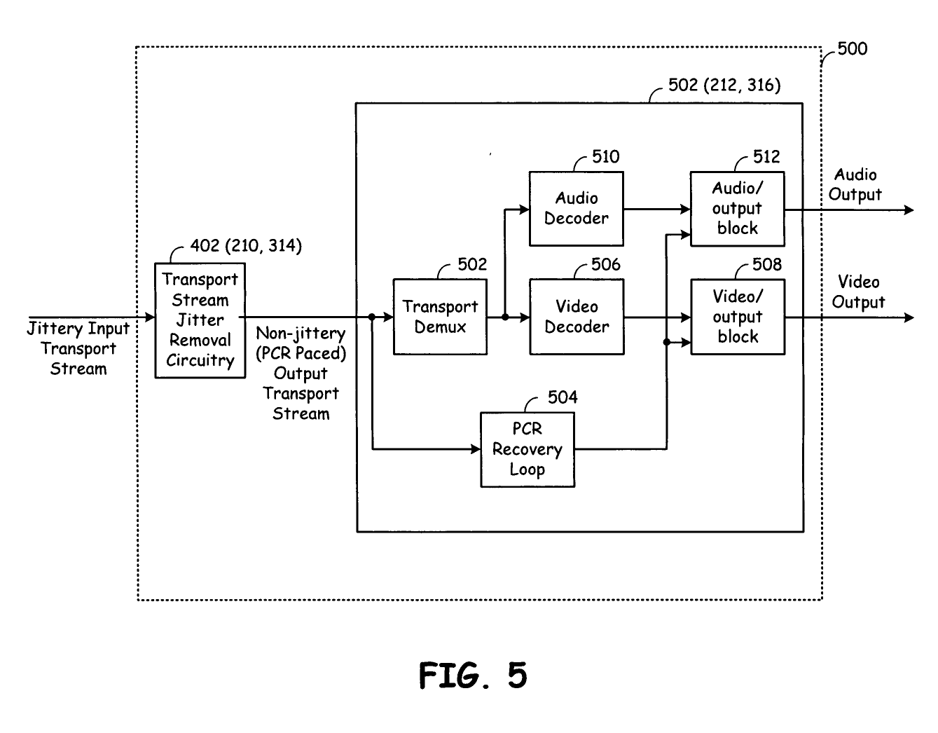

FIG. 5 is a block diagram illustrating a video processing structure that de-jitters a transport stream according to embodiments of the present invention and that decodes an output video. An electronic device 500 is illustrated that includes transport stream jitter removal circuitry 402 and a decoder 502. The structure of the transport stream jitter removal circuitry 402 was previously described in FIG. 4 and will not be described further herein with reference to FIG. 5. Generally, the transport stream jitter removal circuitry receives a jittery input transport stream and produces a non-jittery (PCR paced) output transport stream. The output transport stream is received by decoder 502 (212,316). The decoder 502 includes a transport demultiplexer 502, a PCR recovery loop 504, a video decoder 506, an audio decoder 510, an audio/output block 512, and a video/output block 508. Generally, the non-jittery output transport stream is received both by transport demux 502 and by PCR recovery loop 504. The PCR recovery loop 504 recreates a program clock from the PCRs extracted from the non-jittery output transport stream. Because the non-jittery output transport stream has low jitter content, the PCR recovery loop 504 is able to create an accurate program clock based thereupon.

The transport demultiplexer 502 demultiplexes the transport stream into its audio and video components. The audio components of the transport stream are operated upon by audio decoder 510 while the video components of the transport stream are operated upon by video decoder 506. The audio output block 512 receives the reconstructed program clock in the output of audio decoder 510 and produces audio output based thereupon. The video output block 508 receives the output of video decoder 506 and the recreated program clock from PCR recovery loop 504. The video output block 508 outputs video for subsequent display and processing.

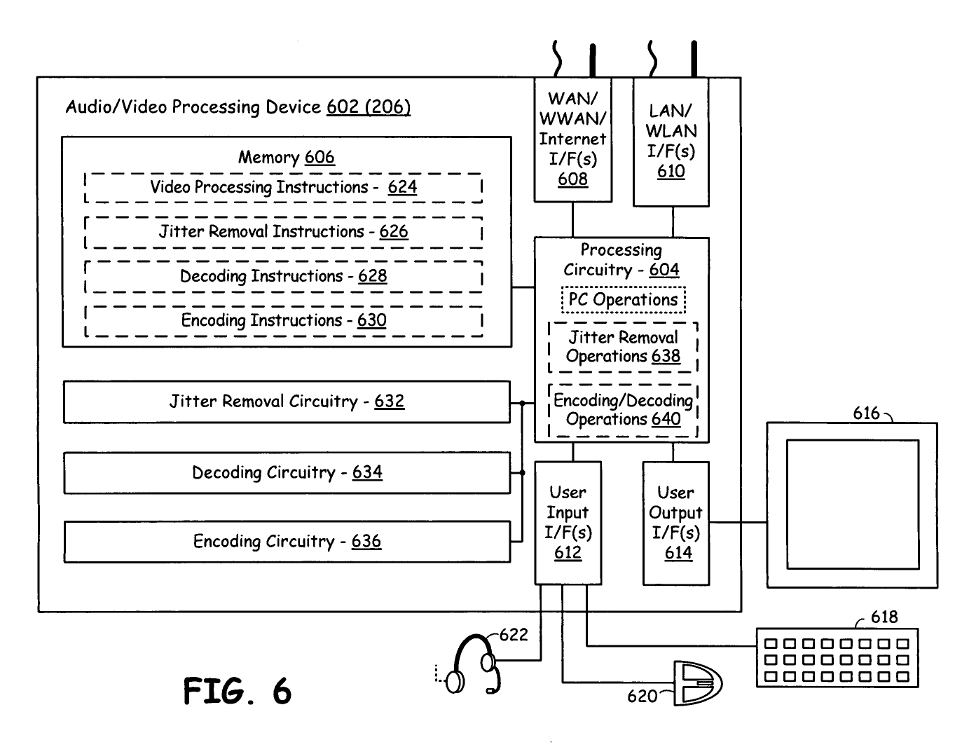

FIG. 6 is a block diagram of an electronic device operable to de-jitter a transport stream, decode the transport stream, and present audio and video content created from the transport stream. The electronic device (audio/video processing device) 602 is representative of one or more of the electronic devices 114-134 of FIG. 1. The components of audio/video processing device 602, also referred to as electronic device, are generically illustrated. Particular embodiments of the electronic device 602 of FIG. 6 may include some, most, or all of the components that are illustrated in FIG. 6.

Generally, the electronic device 602 includes processing circuitry 604, memory 606, first network interface 608, second network interface 610, user input interfaces 612, and user output interfaces 614. The user input interfaces 612 couple to headset 622, mouse 620, and keyboard 618. The user output interfaces 614 couple to audio/video display device 616. The user output interface 614 may also couple to headphone 622. The display device 616 may include a monitor, projector, speakers, and other components that are used to present the audio and video output to a user.

The electronic device 602 embodies the structure and performs operations of the present invention with respect to jitter removal from a received transport stream. In one particular construct of the electronic device 602, dedicated hardware is employed for jitter removal purposes. In such case, the electronic device 602 includes jitter removal circuitry 632. The electronic device may also include decoding circuitry 634. Further, the electronic device 602 may include encoding circuitry 636 that is employed to encode video information into a transport stream that carries transport packets.

Alternatively, the electronic device 602 may include non-dedicated jitter removal circuitry and/or encoding and decoding operations. In such case, the jitter removal operations of electronic device 602 are serviced by processing circuitry 604. The processing circuitry 604 performs, in addition to its PC operations, jitter removal operations 638 and may perform encoding/decoding operations 640. In such case, particular hardware may be included in the processing circuitry 604 to perform the operations 638 and 640. Alternatively, the jitter removal operations 638 and encoding/decoding operations 640 may be accomplished by the execution of software instructions. In this case, the processing circuitry 604 retrieves video processing instruction 624, jitter removal instructions 626, decoding instructions 628, and/or encoding instructions 630 from memory 608. The processing circuitry 604 executes these various instructions 624, 626, 628, and/or 630 to perform the indicated functions. Processing circuitry 604 may include one or more processing devices such as microprocessors, digital signal processors, application specific processors, or other processing type devices.

The audio/video processing device 602 includes the first network interface 608 and the second network interface 610. Generally, the electronic device 602 receives a transport stream (within data packets) via one of the first and second network interfaces 608 and 610. In its other operations, the electronic device 602 may output a transport stream (within data packets) from one of network interfaces 608 or 610. In another operation, the electronic device 602 simply removes jitter from a transport stream carrying video data and outputs the de-jittered transport stream via one of its interfaces 608 and 610.

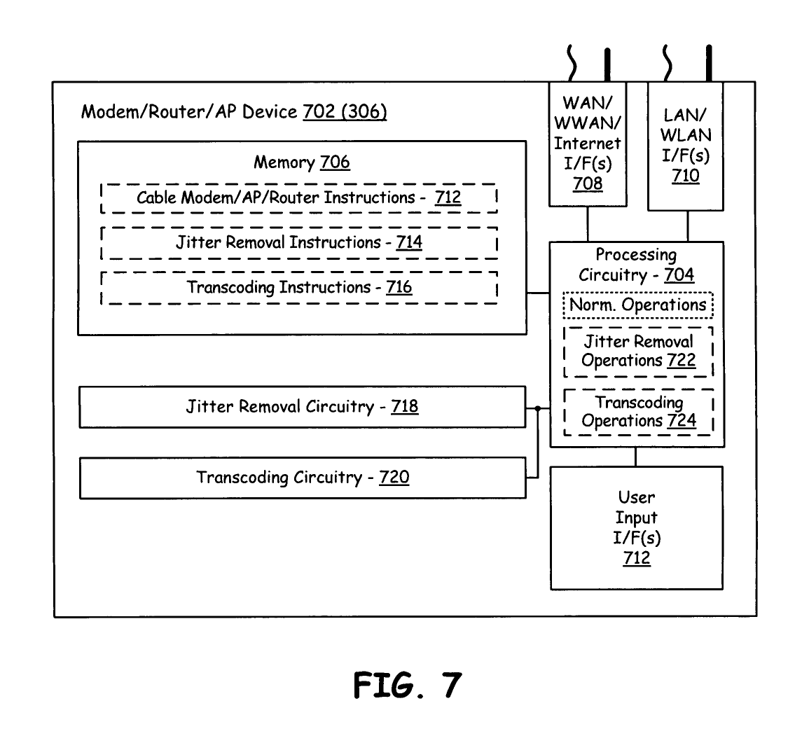

FIG. 7 is a block diagram illustrating an electronic device for receiving a jittery transport stream, de-jittering the received transport stream, and producing an output transport stream having reduced jitter characteristics. A modem/router/access point device 702 is illustrated as the electronic device of FIG. 7. The electronic device 702 may correspond to the modem/gateway/router 306 of FIG. 3. As contrasted to the electronic device 602 of FIG. 6, the electronic device 702 of FIG. 7 receives a jittery transport stream, de-jitters the transport stream, and outputs a de-jittered transport stream. Of course, the transport packets of the transport stream are carried within data packets. To accomplish these operations, the device electronic 702 includes processing circuitry 704, memory 706, first and second network interfaces 708 and 710, user input interface 712, and may include specialized circuitry. The specialized circuitry may include jitter removal circuitry 718 and/or transcoding circuitry 720.

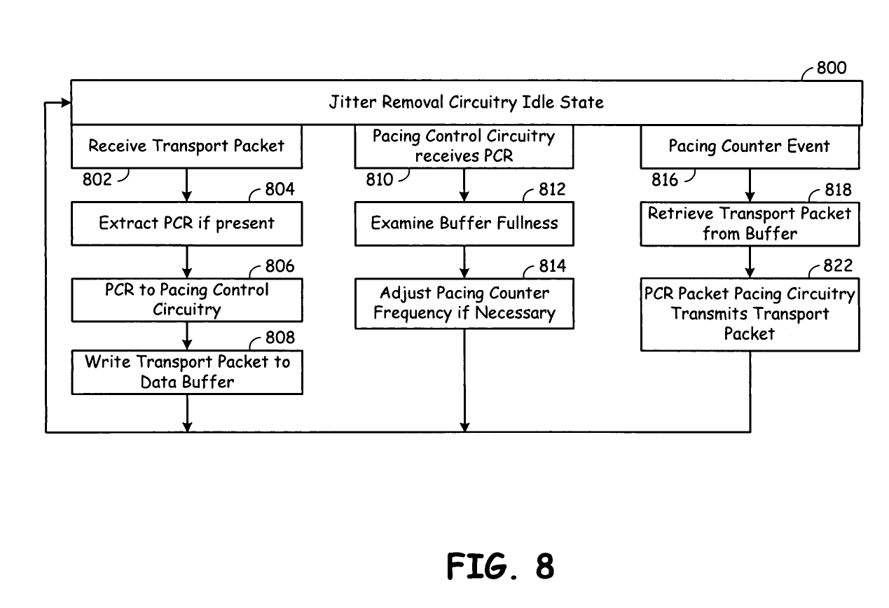

Generally, the device 702 receives a jittery transport stream via one of the network interfaces 708, 710 and removes the jitter from the jittery transport stream. The structure and operations of the jitter removal circuitry was previously described with reference to FIG. 4 and will be further described with reference to FIG. 8. The jitter removal circuitry may be dedicated hardware such as jitter removal circuitry 718 or may be software implemented, or may be a combination of both. In such case, the processing circuitry 704, in addition to its normal operations, performs jitter removal operations 722 and may perform transcoding operations 724. In such case, the processing circuitry 704 may access cable modem/AP/router instructions 712, jitter removal instructions 714, and/or transcoding instructions 716 from memory and process such instructions. Transcoding by device 702 may include altering the resolution of the transport packet, altering the frame rate of the transport stream, and/or making additional alterations of the video content of the transport stream.

According to one operation, the device 702 receives a jittery transport stream via first network interface 708. Then, after de-jittering the transport stream, the electronic device 702 outputs the de-jittered transport stream onto another network via second network interface 710. Alternately, the device 702 may receive the jittery transport stream and transmit the de-jittered transport stream via a single one of the network interfaces 708 and 710.

FIG. 8 is a flow chart illustrating operations according to one or more embodiments of the present invention. According to a first operation of FIG. 8, the jitter removal circuitry waits in an idle state (Step 800). From the idle state, the jitter removal circuitry performs the various operations illustrated that proceed from the idle state 800. In a first operation, the data buffer receives a transport packet, and in some cases an audio packet (Step 802). The jitter removal circuitry then extracts the PCR from the transport packet, if present (Step 804). The PCR is then passed to the pacing control circuitry (Step 806). Then, the data buffer stores the transport packet (and audio packet in some operations) (Step 808). As has been previously described, extraction of the PCR from an incoming transport packet may be performed simply by the pacing control circuitry snooping the transport packets as they are received. From Step 808, operation returns to Step 800.

The pacing control circuitry receives the PCR either by extraction or by receipt from the data buffer (Step 810). Based upon the receipt of the PCR, or based upon another event, e.g., counter event, the pacing control circuitry initiates operations to produce the pacing counter clock adjust signal, if necessary, based upon the PCR. In a first embodiment of this operation, the pacing control circuitry examines the buffer fullness of the data buffer (Step 812). Such examination may be performed absent receipt of the PCR during its normal operations. Based upon the examination of the buffer fullness at Step 812, the pacing control circuitry adjusts the pacing counter frequency if necessary (Step 814). An alternate embodiment described herein, the pacing control circuitry attempts to reconstruct a program clock of the device that created the transport stream and adjusts the pacing counter frequency if necessary at Step 814 based upon this estimation.

The jittery removal circuitry produces the de-jittered transport stream as its output. Upon investigating the pacing counter clock, the PCR pacing circuitry determines when a pacing counter event has been met (Step 816). Upon meeting the pacing counter event, the PCR packet pacing circuitry retrieves a transport packet from the data buffer (Step 818). The pacing control circuitry then outputs the retrieved transport packet (Step 822). Steps 818 and or 822 may include retrieving audio data and transmitting the audio data as well. From Steps 808, 814, and 822 operation returns to Step 800.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Likewise, a first circuit and a second circuit may be combined in one embodiment into a single circuit or, in another embodiment, operate independently perhaps in separate chips. The term “chip”, as used herein, refers to an integrated circuit. Circuits and circuitry may comprise general or specific purpose hardware, or may comprise such hardware and associated software such as firmware or object code.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1. A system for de-jittering a transport stream, at least some transport packets of the transport stream containing Program Clock References (PCRs), the system comprising:
a data buffer operable to receive the transport packets and to store the transport packets;
pacing counter clock circuitry operable to produce a pacing counter clock and to adjust a frequency of the pacing counter clock based upon a pacing counter clock adjust signal;
pacing control circuitry operable to produce the pacing counter clock adjust signal based upon receipt of the transport packets; and
PCR packet pacing circuitry operable to:
receive the pacing counter clock;
based upon the packing counter clock, retrieve transport packets from the data buffer; and
transmit the retrieved transport packets as an output transport stream.

2. The system of claim 1, wherein in producing the pacing counter clock adjust signal based upon receipt of the transport packets, the pacing control circuitry is operable to:
receive the PCRs of the transport packets;
process the PCRs of the transport packets to estimate a frequency of a program clock of an electronic device producing the transport stream;
compare the estimated frequency of the program clock of the electronic device producing the transport packets containing the PCRs to the pacing counter clock; and
produce the clock adjust signal based upon the comparison.

3. The system of claim 1, wherein in producing the pacing counter clock adjust signal based upon receipt of the transport packets, the pacing control circuitry is operable to:
characterize a fullness of the data buffer;
compare the fullness of the data buffer to a fullness threshold; and
based upon the comparison, produce the pacing counter clock adjust signal.

4. The system of claim 1, wherein:
the transport stream has first jitter characteristics; and
the output transport stream has second jitter characteristics that are less jittery than the first jitter characteristics.

5. The system of claim 1, further comprising at least one wireless interface operable to receive data packets carrying the transport stream.

6. The system of claim 1, wherein data packets carrying the transport stream traverse at least one Internet Protocol (IP) based network.

7. The system of claim 1, further comprising a decoder operable to decode the output transport stream to produce output video data and output audio data.

8. An electronic device comprising:
at least one network interface operable to receive data packets carrying transport packets of a transport stream, at least some transport packets of the transport stream carrying Program Clock References (PCRs); and
jitter removal circuitry coupled to the network interface and comprising:
a data buffer operable to receive the transport packets and to store the transport packets;
pacing counter clock circuitry operable to produce a pacing counter clock and to adjust a frequency of the pacing counter clock based upon a pacing counter clock adjust signal;
pacing control circuitry operable to produce the pacing counter clock adjust signal based upon receipt of the transport packets; and
PCR packet pacing circuitry operable to:
receive the pacing counter clock;
based upon the packing counter clock, retrieve transport packets from the data buffer; and
transmit the retrieved transport packets as an output transport stream.

9. The electronic device of claim 8, wherein the at least one network interface includes a wireless interface that is operable to receive the data packets carrying the transport stream.

10. The electronic device of claim 8, wherein data packets carrying the transport stream traverse at least one Internet Protocol (IP) based network.

11. The electronic device of claim 8, wherein in producing the pacing counter clock adjust signal based upon receipt of the transport packets, the pacing control circuitry is operable to:
receive the PCRs of the transport packets;
process the PCRs of the transport packets to estimate a frequency of a program clock of an electronic device producing the transport stream;
compare the estimated frequency of the program clock of the electronic device producing the transport packets containing the PCRs to the pacing counter clock; and
produce the clock adjust signal based upon the comparison.

12. The electronic device of claim 8, wherein in producing the pacing counter clock adjust signal based upon receipt of the transport packets, the pacing control circuitry is operable to:
characterize a fullness of the data buffer;
compare the fullness of the data buffer to a fullness threshold; and
based upon the comparison, produce the pacing counter clock adjust signal.

13. The system of claim 8, wherein:
the transport stream has first jitter characteristics; and
the output transport stream has second jitter characteristics that are less jittery than the first jitter characteristics.

14. The electronic device of claim 8, further comprising:
a decoder operable to decode the output transport stream to produce output video data and output audio data;
at least one display operable to display the output video data; and
at least one audio interface operable to present the output audio data.

15. The electronic device of claim 8, wherein:
the network interface comprises an uplink network interface and a downlink network interface; and
the electronic device operates as at least one of a wired modem, a wired router, a wired switch, a set top box, a wireless access point, a wireless router, and a wireless switch.

16. A method for de-jittering a transport stream, at least some transport packets of the transport stream carrying Program Clock References (PCRs), the method comprising:
receiving the transport packets via a network interface;
storing the transport packets in a data buffer;
producing a pacing counter clock;
producing a pacing counter clock adjust signal based upon receipt of the transport packets;
adjusting a frequency of the pacing counter clock based upon the pacing counter clock adjust signal;
based upon the packing counter clock, retrieving transport packets from the data buffer; and
outputting the retrieved transport packets as an output transport stream.

17. The method of claim 16, wherein producing the pacing counter clock adjust signal based upon receipt of the transport packets comprises:
receiving the PCRs of the transport packets;
processing the PCRs of the transport packets to estimate a frequency of a program clock of an electronic device producing the transport stream;
comparing the estimated frequency of the program clock of the electronic device producing the transport packets containing the PCRs to the pacing counter clock; and
producing the clock adjust signal based upon the comparison.

18. The method of claim 16, wherein producing the pacing counter clock adjust signal based upon receipt of the transport packets comprises:
characterizing a fullness of the data buffer;
comparing the fullness of the data buffer to a fullness threshold; and
based upon the comparison, producing the pacing counter clock adjust signal.

19. The method of claim 16, wherein:
the transport stream has first jitter characteristics; and
the output transport stream has second jitter characteristics that are less jittery than the first jitter characteristics.

20. The method of claim 16, further comprising decoding the output transport stream to produce output video data and output audio data.

21. The method of claim 16, wherein outputting the retrieved transport packets as an output transport stream includes outputting the transport stream via a network interface to a serviced network.

22. The method of claim 16, wherein outputting the retrieved transport packets as an output transport stream includes outputting the transport stream to a coupled decoder.
